(19) United States
(12) Patent Application Publication
(10) Pub. No.: US 2004/0261635 A1
(43) Pub. Date: Dec. 30, 2004

(54) Roller-sheller for cereals

(75) Inventors: Frank-Otto Gorlitz, Braunschweig (DE); Edmund Chylinski, Braunschweig (DE)

Correspondence Address: MERCHANT & GOULD PC, P.O. BOX 2903, MINNEAPOLIS, MN, 55402-0903, US

(73) Assignee: BUHLER AG, Uzwil (CH)

(21) Appl. No.: 10/875,848

(22) Filed: Jun. 24, 2004

(30) Foreign Application Priority Data
Jun. 25, 2003 (DE) 103 28 751.5

(51) Int. Cl. B03B 5/08; B02B 3/02

(52) U.S. Cl. 99/617; 209/667

(57) ABSTRACT

The invention relates to a roller-sheller, in particular to a rubber roller-sheller (1) for shelling rice or other cereals.

The roller-sheller has a drive in which the drive belt for the wheels of the rollers (7, 8) as well as the drive wheel (21) and a tensioning roller (24) is a double-toothed belt (20).

The invention relates to a roller-sheller for cereals, in particular a rubber roller-sheller for shelling rice and other cereals, preferably for removing the raw grain shells according to the preamble to the patent claim.

Generic rubber roller-shellers are known from DE-C-2705334, for example. These have a pair of rubber rollers with pneumatically adjustable contact pressure. The raw rice is fed centrally via a feed pipe into the roller gap of the horizontally arranged rollers.

The rollers are cantilevered. A belt running around the driving roller, both rollers and a balancing roller generates a constant belt tension. In order to achieve a uniform wear for both rollers, the latter must be switched around repeatedly, which not only increases the maintenance outlay, but also shifts the optimal feed point relative to the roller gap.

In drives with V belt or twin V belt, slip on the belt drive is unavoidable (relative speed and diameter of rollers, resultant small diameter of drive wheel). In addition to diminished performance with respect to throughput and shelling level, a high heat buildup takes place on the wheels.

GB-PS 797372 provided a roller gap-dependent feed chute that can pivot around a fulcrum to offset the roller gap shift. Both the rollers and the feed chute are inclined, wherein the feed chute is roughly perpendicular to the connecting line of the roller axes. The feed chute is actuated via a lever mechanism, and corrected via the moveable roller as a function of the roller diameter. Such an inclined chute simultaneously permits a purposefully thin product veil or feed layers only a few grains thick, and the grain feed rate can obviously be optimized.

The object of the invention is to develop a roller-sheller for cereals whose drive and overdrive system are simplified and more functionally reliable. This object is achieved using the characterizing features of the claim.

The invention proceeds from a drive or overdrive according to DE-C-2705334, and proposes the use of a slip-free double-toothed belt. This makes it possible to reduce the drive power at a constant performance or shelling level. It was surprisingly found that the fracture growth rate remains low.

Other embodiments are disclosed in the subclaims.

The feed chute is directly adjusted relative to the roller gap by shifting the bearing point (casing) of the moveable roller. As a result, adjustment parameters need not be measured on rotating rollers. The feed chute is adjusted in a structurally simple manner, and without the intermediate signal conversion steps for separate adjustment devices. Feeding takes place via a vibrating channel on the feed chute.

The invention will be described in greater detail below in an embodiment based on a drawing. Shown on:

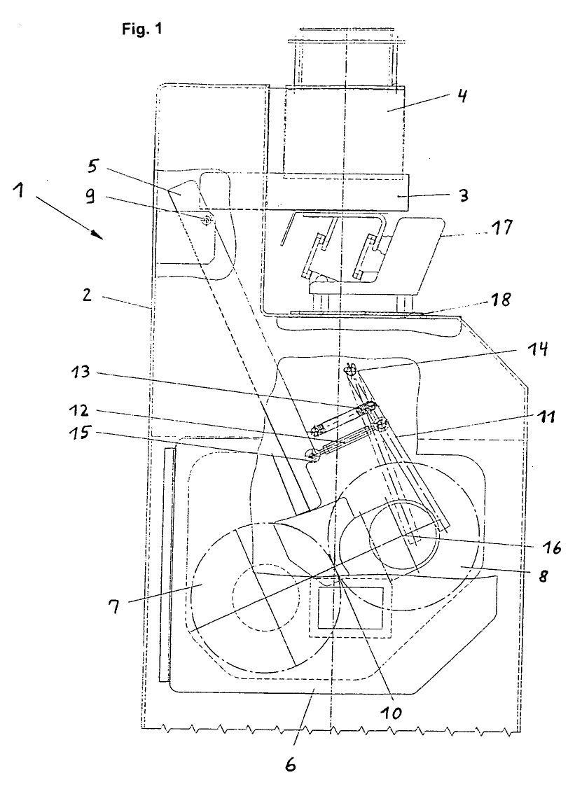

FIG. 1 is a simplified sectional drawing of a roller-sheller.

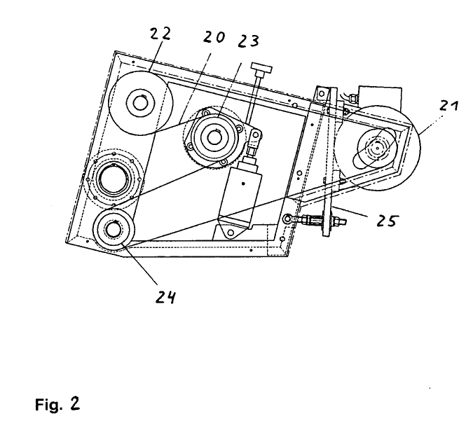

FIG. 2 is a basic diagram of the drive.

The rubber roller-sheller 1 for shelling rice has a casing 2, whose upper section incorporates a vibrating feeder 3 above a material inlet 4. Provided below the vibrating feeder 3 is an inclined pair of rubber rollers 7 and 8, with the loose roller 8. A feed chute 5 is situated between the vibrating feeder 3 and roller pair so that it can pivot in such a way that the feed chute 5 is roughly perpendicular to the connecting line of the axes of rubber rollers 7, 8, wherein the floor of the feed chute 5 and the roller gap 10 form a line. Targeted operation of the vibrating feeder 3 makes it possible to supply the rice grains to the roller gap 10 in only 1-2 grain layers via the feed chute 5. To this end, the vibrating feeder has a vibrating chute 17 with a pressure relief cone in the inlet. The excitation frequency of the vibrating channel 17 can be adjusted to the groove system by means of a frequency converter controller 18.

Provided below the rollers 7, 8 is a material outlet 6 for the shelled grains and shells, from which the shelled products get into a shell separator (not shown).

A double-toothed belt 20 envelops at least approx. 180° of a drive wheel 21 of the drive motor, a wheel 22 of the moveable shelling roller 8, a drive wheel 23 of the fixed shelling roller 7 and a tensioning roller 24. The tensioning roller 24 and wheel 22 (along with roller 7) are arranged on a shared carrier (not shown) so that they can pivot.

Provided on the straining screws for the drive (not shown) is a spring-mounted substrate, which enables a constant tensioning of the double-toothed belt 20 given an appropriate pre-tensioning.

The feed chute 5 is adjusted relative to the roller gap 10 using a lever mechanism comprised of a short lever 12 hinged to the feed chute 5 and a long lever 11 pivoted to the latter. The long lever 11 can be pivoted around a fulcrum 14 on the casing 2, and the short lever 12 can be pivoted around a fulcrum 15 on the feed chute 5. The free end of the long lever 11 is joined with the bearing point 16 of the loose roller 8. A tension spring 13 presses the long lever 11 against the bearing casing of the loose roller 8. The long lever 11 hence abuts the bearing point 16 of the loose roller 8, tensioned by the spring 13. The short lever 12 connects the long lever 11 with the feed chute 5.

The rollers 7, 8 are secured with taper lock bushings. The shelling force of the rollers 7, 8 can be adjusted by the motor weight of the drive and counter-torque generation via controlled air pressure using pneumatic cylinders. The drive has a rocker with belt guide (not shown), which ensures a uniform belt length when the rocker is swiveled.

With the fulcrums of the levers 11 and 12 in the appropriate position and given the corresponding length correlations, progressive motion adjustments can be made to the wear of rollers 7 and 8 in addition to linear ones.

Situated under the motor plate 25 is a spring-mounted substrate held by straining screws to the motor plate to establish a constant belt tensioning.

### Reference symbols

1 rubber roller sheller

2 casing

3 vibrating feeder

4 material inlet

5 feed chute

6 material outlet

7 (fixed) roller

8 (loose) roller

9 fulcrum

10 roller gap

11 (long) lever

12 (short) lever

13 tension spring

14 fulcrum

15 fulcrum

16 bearing point

17 vibrating channel

18 frequency converter controller

20 double toothed belt

21 drive wheel

22 wheel

23 drive wheel

24 tensioning roller

25 motor plate

1. A roller-sheller for cereals, in particular rubber roller-sheller (1) for shelling rice and other cereals, which has a casing (2) with an upper material inlet (4) and lower material outlet (6), a feeder for the cereals, a pair of inclined rollers (7, 8), whose drive wheels (22, 23) are enveloped at least partially by a drive belt, wherein the drive belt is a double-toothed belt (20).

2. The roller-sheller according to claim 1, wherein the roller (7) with the wheel (22) and a tensioning roller (24) are arranged on a shared carrier so that they can pivot.

3. The roller-sheller according to claim 1, wherein it has an inclined and adjustable feed chute (5) that is nearly perpendicular to the connecting line of the axes of rollers (7, 8), and a lever (11) mounted at one end in a fulcrum (14) and hinged at the other end at the bearing point (16) of the loose roller (8), pivoted to a short lever (12), wherein the short lever (12) hinges the long lever (11) with the feed chute (5).

4. The roller-sheller according to claim 3, wherein the feeder has a vibrating feeder (3) with a vibrating channel (17), which has a pressure relief cone in the inlet.

5. The roller-sheller according to claim 3, wherein a shell separator is arranged under the material outlet (6).

6. The roller-sheller according to claim 2, wherein the excitation frequency of the vibrating channel (17) is adjustable.
